(19) United States
(12) Patent Application Publication
(10) Pub. No.: US 2024/0383455 A1
(43) Pub. Date: Nov. 21, 2024

(54) APPARATUS OF CONTROLLING PARKING OF BRAKE FOR AIRCRAFT AND METHOD THEREOF

(71) Applicant: DAWIN FRICTION, Ltd., Incheon (KR)

(72) Inventors: Deuk-Soo KANG, Seoul (KR); Beom-Joo LEE, Incheon (KR); Young-Chan JU, Seongnam (KR); Se-Yong LEE, Incheon (KR)

(21) Appl. No.: 18/199,310

(22) Filed: May 18, 2023

(51) Int. Cl. B60T 8/17

(52) U.S. Cl. CPC B60T 8/1703; B60T 2201/10; B60T 2220/04

(57) ABSTRACT

The present disclosure relates to an apparatus of controlling a parking state of a brake for an aircraft and a method thereof. The apparatus comprises a data input unit of an aircraft driving state; an aircraft control unit determining whether a parking locking function is activated based on the data of the data input unit and outputting a parking control signal; a motor controller outputting a parking locking signal for controlling an operation of an electric motor of a brake assembly according to the parking control signal of the aircraft control unit; and a parking locking mechanism for stopping rotation of the electric motor in response to a parking locking signal from the motor controller and locking a parking state of the brake assembly.

### BACKGROUND OF THE DISCLOSURE

### Technical Field

The present disclosure relates to an apparatus of controlling a parking state of a brake for an aircraft and a method thereof and in particular, an apparatus of controlling a parking state of a brake for an aircraft and a method thereof capable of preventing movement of the aircraft by locking a parking state of the brake after the aircraft arrives at a destination.

### Description of Related Art

A wheel brake assembly is mounted on an axle of a landing gear of an aircraft to decelerate the aircraft when landing on the main runway or to decelerate or stop the aircraft while driving on the auxiliary runway.

In general, the wheel brake assembly is classified into a caliper-type applied for a small braking load and a disc-type applied for a large braking load. The disc-type wheel brake assembly has a structure provided with a disc pack in which a plurality of rotor discs and a plurality of stator discs are alternately assembled to perform a braking operation. The caliper-type wheel brake assembly has a pair of calipers each having friction pads and performs braking operation by pressing the friction pads against a rotor disc rotating together with the axle. The present invention is described and limited to the caliper-type wheel brake assembly hereinbelow.

The caliper-type wheel brake assembly has a brake actuator for converting a rotational force of a motor into a linear displacement. The brake actuator is configured to apply a pressure to the pair of calipers to perform a braking operation by contacting the friction pads with the rotor disc which is coupled to the axle and rotates together, stopping a rotation of a wheel with respect to the ground.

The brake actuator includes a hydraulic actuator which presses a pusher against the disc pack using a pressure oil or an electromechanical (or electric) actuator which uses a rotational force of a motor to presses the pusher against the disc pack.

The electromechanical actuator has only a difference in specifications according to the required braking force, but it has a similar basic configuration and operation for large or small aircraft. A variety of wheel brake assemblies has been developed and applied in the aerospace industry in which various technologies are implemented for required functions or characteristics.

Recently, interests in an Urban Air Mobility (UAM) using drones or small aircrafts have been increasing to relieve traffic congestion problems in large cities. For implementing the UAM, several technologies for UAM structures and methods for operating an electric vertical take-off and landing (eVTOL), personal air vehicles (PAV) and the like have been proposed.

The UAM is designed to operate in a vertical take-off and landing manner due to using the limited urban space, in which a small UAM carrying 5 or less people including a pilot or a medium-sized UAM carrying about 20 people may be considered. Such the UAM requires a brake operation to decelerate or stop itself while traveling to a desired place, if necessary, in connection with takeoff and landing operations.

For such the brake operation, the wheel brake assembly should be installed in the landing gear assembly. The wheel brake assembly for the UAM may be constructed by miniaturizing the design of a disc-type electromechanical or electric brake assembly which has been applied to an existing general commercial aircraft.

Since the UAM has a smaller body weight and less braking load (torque) than the commercial aircraft. For example, in the case of a 5 to 20-seater UAM, a disc type or a caliper type wheel brake assembly which may generate a dynamic braking force ranging from about 12,000 N to 30,000 N is provided on the axle to perform the required braking operation.

Accordingly, there has been a need to develop a technology for an apparatus of controlling a parking state of a brake for an aircraft and a method thereof which may be applied for a small-sized aircraft like the UAM and prevent the aircraft from moving arbitrarily after the aircraft arrives at a destination such as a desired terminal or a mooring stop by locking a parking state of the aircraft.

### SUMMARY OF THE DISCLOSURE

The present disclosure has been made in efforts to solve the problems of the related art and the present disclosure is directed to providing an apparatus of controlling a parking state of a brake for an aircraft and a method thereof which is applicable for a small or medium-sized UAM and reliably prevents the aircraft from moving arbitrarily after the aircraft arrives at a destination by locking a parking state of the aircraft.

The apparatus of controlling a parking state of a brake for an aircraft according to an exemplary embodiment of the present disclosure, comprising a data input unit of an aircraft driving state: an aircraft control unit determining whether a parking locking function is activated based on the data of the data input unit and outputting a parking control signal: a motor controller outputting a parking locking signal for locking an operation of an electric motor of a brake assembly according to the parking control signal of the aircraft control unit; and a parking locking mechanism for locking a parking state where a rotation of an electric motor is stopped in response to a parking locking signal from the motor controller and for maintaining the locked parking state thereof.

The data input unit of the aircraft driving state may be configured to receive signals detected by a plurality of sensors.

The plurality of sensors may include at least one of a brake pedal position sensor, a parking lever (button) sensor, and an aircraft start sensor.

The aircraft control unit may be configured to determine whether an activation condition of a parking locking function is satisfied based on the data collected via the data input unit of the aircraft driving state from the plurality of sensors.

The activation condition of the parking locking function may be determined based on signals from the brake pedal position sensor, the parking lever (button) sensor, and the aircraft start sensor.

The activation condition of the parking locking function may be determined by additionally including signals from a seat belt sensor and a door sensor.

The parking locking mechanism may be configured to perform a parking locking function by stopping a rotation of an electric motor shaft using a friction member or a one-way clutch operated by a solenoid according to a parking locking signal from the motor controller.

The aircraft control unit may further comprise a display unit for externally displaying a parking locking state by the parking locking mechanism.

The aircraft control unit may further comprises a communication unit for notifying a parking locking state by the parking locking mechanism to a pilot's mobile phone.

A method of controlling a parking state of a brake for an aircraft according to an exemplary embodiment of the present disclosure may comprise steps of: inputting driving state data of an aircraft; determining whether an activation condition of a parking locking function is satisfied by an aircraft control unit based on the input data: outputting a parking control signal to a motor controller when the activation condition of the parking locking function is satisfied by the aircraft control unit; and locking a parking state where a rotation of an electric motor is stopped via a parking locking mechanism based on a parking locking signal from the motor controller.

The step of inputting driving state data may receive signals detected by a plurality of sensors.

The plurality of sensors may include at least one of a brake pedal position sensor, a parking lever (button) sensor, an aircraft start sensor, a seat belt sensor, and a door sensor.

In the step of determining whether an activation condition of a parking locking function is satisfied, the activation condition of the parking locking function may be met when the brake pedal position sensor is ON, the parking lever (button) sensor is ON, and the aircraft start sensor is OFF.

The activation condition of the parking locking function may be further determined by whether the seat belt sensor is OFF and the door sensor is ON for a predetermined period of time.

The predetermined period of time may be preferably set to 3 minutes.

In a state where a rotation of a rotor disc is stopped via a pair of calipers by manipulation of the brake pedal or the parking lever (button) by the pilot, the parking locking step may be performed by applying a parking locking signal with a first current value to a solenoid by the motor controller, locking a parking state where a rotation of an electric motor shaft is stopped via a parking locking mechanism including a friction member or a one-way clutch which is operated by the solenoid in response to a parking locking signal, and maintaining the locked parking state.

The unlocking of the parking state may be performed by applying a parking release signal with a second current value to the solenoid by the motor controller, and unlocking the parking state via the parking locking mechanism including a friction member or a one-way clutch operated by the solenoid to enable the electric motor shaft to rotate freely.

In the parking control method of the present disclosure, the motor controller may be connected to the aircraft control unit through a Controller Area Network (CAN) communication to control the electric motor.

In the parking control method of the present disclosure, the locked parking state may be displayed by sound or lighting of a lamp.

In the parking control method of the present disclosure, the locked parking state may be delivered to the pilot's mobile phone as a push message through a wireless communication.

The apparatus of controlling a parking state of a brake for an aircraft and a method thereof according to the present disclosure as described above may have the following advantages.

First, after the aircraft arrives at the destination and stops, if the conditions for activating the parking locking function are satisfied based on the driving state data of the aircraft, the aircraft's parking state may be locked and maintained to reliably prevent an arbitrary movement of the aircraft.

Second, the locked parking state of the aircraft may be indicated by sound or lighting of lamps, so that the pilot may confirm that the locking operation has been completely performed.

Third, the present invention may notify the pilot of completion of locking operation of the parking locking mechanism by sending a push message to the pilot's mobile phone.

The information included in this Background of the present disclosure is only for enhancement of understanding of the general background of the present disclosure and may not be taken as an acknowledgement or any form of suggestion that this information forms the prior art already known to a person skilled in the art.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not intended to limit the present disclosure. In the figures, reference numbers refer to the same or equivalent parts of the present invention throughout the several figures of the drawing.

FIG. 1 is a schematic perspective view showing that a caliper-type wheel brake assembly for an aircraft provided with an apparatus of controlling a parking state of a brake for the aircraft according to an exemplary embodiment of the present disclosure;

FIG. 2 is a block diagram showing the apparatus of controlling the parking state of the brake for the aircraft according to an exemplary embodiment of the present disclosure;

FIG. 3 is a flow chart illustrating a method of controlling a parking state of a brake for an aircraft according to an exemplary embodiment of the present disclosure:

FIG. 4 is a cross-sectional view schematically showing a brake actuator of the wheel brake assembly for the aircraft provided with the apparatus of controlling the parking state of the present disclosure; and

FIG. 5 is a partial cross-sectional view illustrating a braking operation using a pair of calipers of the wheel brake assembly for the aircraft provided with the apparatus of controlling the parking state of the present disclosure.

### DESCRIPTION OF SPECIFIC EMBODIMENTS

Reference will now be made in detail to various embodiments of the present disclosure(s), examples of which are illustrated in the accompanying drawings and described below. While the present disclosure(s) will be described in conjunction with exemplary embodiments of the present disclosure, it should be understood that this is not intended to limit the present disclosure to the specific embodiments and includes all modifications, equivalents, and substitutes included in the spirit and scope of the present disclosure. In describing the embodiments of the present disclosure, where it has been determined that a detailed description of related known technologies may obscure the gist of the present disclosure, a detailed description thereof has been omitted. When a component, device, element, or the like, of the present disclosure, is described as having a purpose or performing an operation, function, or the like, the component, device, or element should be considered herein as being “configured to” meet that purpose or to perform that operation or function.

In describing the present invention, specific descriptions of known functions or configurations of the electromechanical or electric brake actuator will be omitted or briefly described to the extent necessary to clarify the gist of the present disclosure.

First, a configuration of a caliper-type wheel brake assembly 100 for an aircraft provided with an apparatus 200 of controlling a parking state according to an exemplary embodiment of the present disclosure will be briefly described.

The caliper-type wheel brake assembly (hereinafter referred to as a “brake assembly”) 100 may include a brake housing 20 fixedly installed in a stationary state with respect to a rotating axle 12 having a rotor disc 10; a brake actuator 30 disposed within the housing 20 to generate a braking force with respect to the rotor disc 10; and a pair of calipers 40 operated by the brake actuator 30 to stop a rotation of the rotor disc 10.

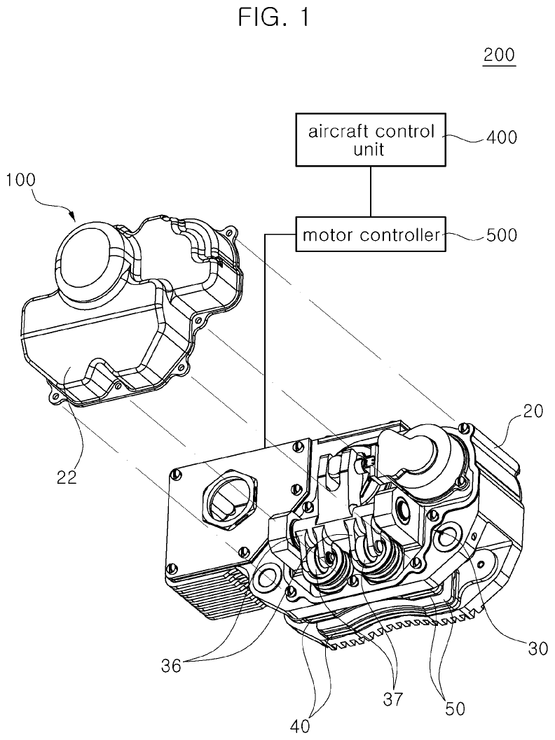

The housing 20 may have a substantially rectangular box structure and may be made of steel such as stainless steel. As shown in FIG. 1, the housing 20 may be assembled with a detachable cover 22 that protects internal parts and allows them to be inspected as needed.

The brake actuator 30 may be in a structure preferably using an electric motor, and basic configurations and operations of an electromechanical or electric brake actuator employed with the electric motor are well known in the art. Accordingly, a detailed description of the electromechanical or electric brake actuator will be omitted or briefly described within the scope necessary for description of the present invention.

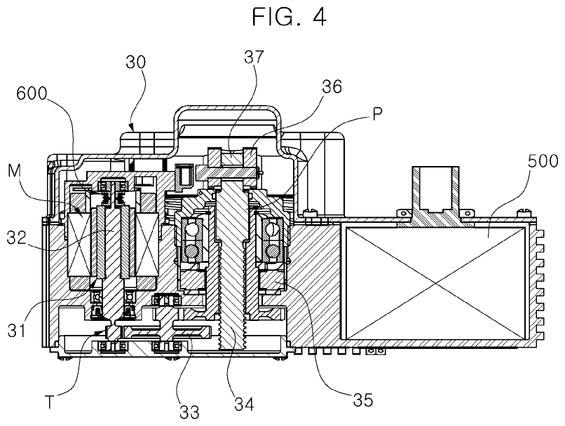

As shown in FIG. 4, the brake actuator 30 may be accommodated in the housing 20. The brake actuator 30 may include a motor unit M which generates a rotational movement by receiving electricity, a power transmission unit T transmitting the rotational movement of the motor unit M, and a pressing unit P which converts the rotational movement into a linear displacement for pressing the pair of caliper 40 to cause a braking operation.

The motor unit M, in general, may include an electric motor 31 with a motor shaft 32, a motor controller 500 for driving or stopping the electric motor M.

The power transmission unit T may include a gear train consisting of a plurality of spur gears 33 which transmits the rotational force outputting from the motor shaft 32 of the electric motor 31 to the pressing unit P.

The pressing unit P may include a ball screw 34 configured to generate a linear displacement by receiving the rotational force transmitted from the power transmission unit T, a load cell 35 configured to measure a load transmitted by the braking operation and to output a signal to a motor controller 500 to control the electric motor 31.

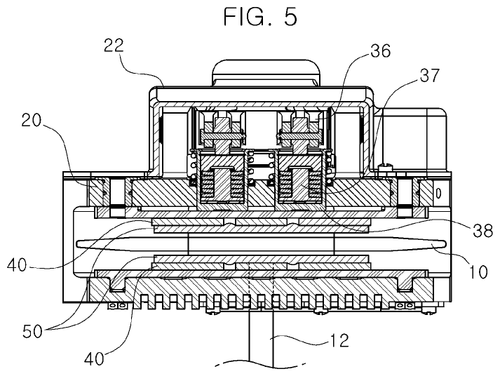

In addition, as shown in FIGS. 4 and 5, the pressing unit P may further include a rocker arm 36 pivotally coupled to an upper end of the ball screw 34 and configured to generate a linear displacement, a push rod 37 pivotally connected to the rocker arm 36 to move upwards or downwards, and a piston 38 coupled to a lower end of the push rod 37 and configured to press or release the pair of calipers 40.

Referring to FIG. 5, the pair of calipers 40 may have friction pads 50 mounted on facing surfaces thereof. Therefore, when the piston 38 presses the pair of calipers 4, the friction pads 50 may contact the rotating rotor disc 10 and generate a frictional force to stop a rotation of the rotor disc 10.

Next, an apparatus 200 of controlling a parking state of a brake for an aircraft (referred to as “parking control apparatus 200” hereinafter) according to an exemplary embodiment of the present disclosure which is applied to a brake assembly 100 for the air craft configured as described above will be explained in detail.

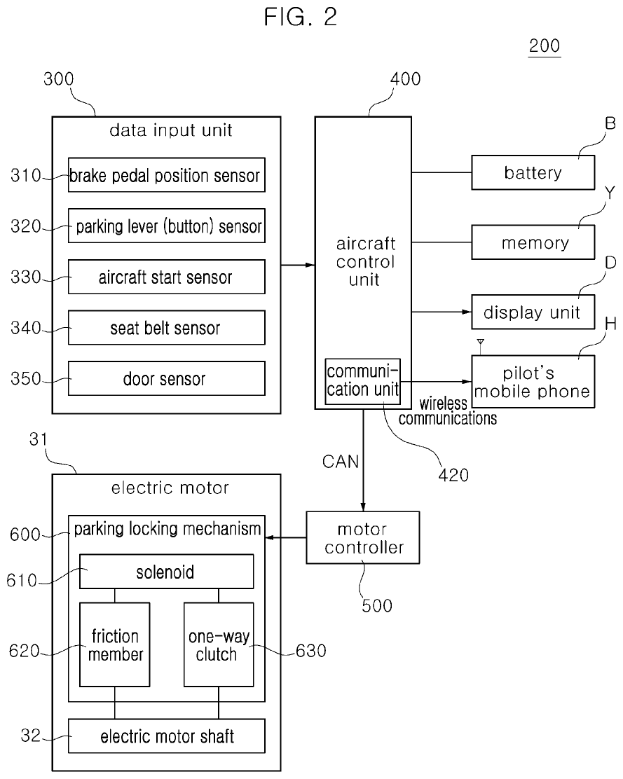

Referring to FIG. 2, the parking control apparatus 200 may comprises a data input unit 300 of an aircraft driving state: an aircraft control unit 400 determining whether a parking locking function is activated based on the data of the data input unit 300 and outputting a parking control signal: a motor controller 500 outputting a parking locking signal for locking an operation of an electric motor 31 of a brake assembly 100 according to the parking control signal of the aircraft control unit 400; and a parking locking mechanism 600 for locking a parking state where a rotation of an electric motor 31 is stopped according to a parking locking signal from the motor controller 500.

The data input unit 300 of the aircraft driving state part may receive signals detected by a plurality of sensors and may input such the signals to the aircraft control unit 400.

The plurality of sensors may include at least one of a brake pedal position sensor 310, a parking lever (button) sensor 320, and an aircraft start sensor 330. The brake pedal position sensor 310 may detect a position of the brake pedal when the pilot steps on the brake pedal to stop the aircraft. The parking lever (button) sensor 320 may detect manipulation of the parking lever or button (not shown) by the pilot after parking the aircraft at a destination. The aircraft start sensor 330 may detect ON/OFF of a power switch to drive or stop a drive motor (not shown) of the aircraft.

The present invention may further include a seat belt sensor 340 for detecting whether the pilot fastens a seat belt (not shown) or not and a door sensor 350 for detecting whether the pilot opens or closes a pilot compartment door (not shown).

In addition, the aircraft control unit 400 of the present disclosure may be connected to the battery B and determines whether the activation condition of the parking locking function is satisfied based on the information collected through the data input unit 300 from the plurality of sensors. The battery B may include a 48V high voltage battery and a 12V low voltage battery.

The activation condition of the parking locking function is to determine whether to perform the parking locking function. The activation condition of the parking locking may be determined based on detection signals of at least one of the brake pedal position sensor 310, the parking lever (button) sensor 320, the aircraft start sensor 330, the seat belt sensor 340, and the door sensor 350.

The parking locking mechanism 600 may implement a conventional locking mechanism where a friction pad member (620) or a one-way clutch (630) is operated by a solenoid (610) to stop a rotation of the electric motor shaft 32 of the electric motor 31 for making a parking state and to lock such the parking state in response to a parking locking signal from the motor controller 500. Since various structures of the conventional locking mechanism have been well known and are not the subject of the present disclosure, a detailed description thereof will be omitted.

The aircraft control unit 400 may further include a display unit D to externally display the parking locking state by the parking locking mechanism 600, for example, on a dash panel of the pilot compartment.

The aircraft control unit 400 may further include a communication unit 420 with a communication modem (not shown) which notify the pilot's mobile phone H of a completion of the parking locking operation by the parking locking mechanism 600 through a push message using wireless communication.

Hereinafter, a method of controlling a parking operation of an aircraft using the parking control apparatus 200 for an aircraft brake according to an exemplary embodiment of the present disclosure as configured above will be described.

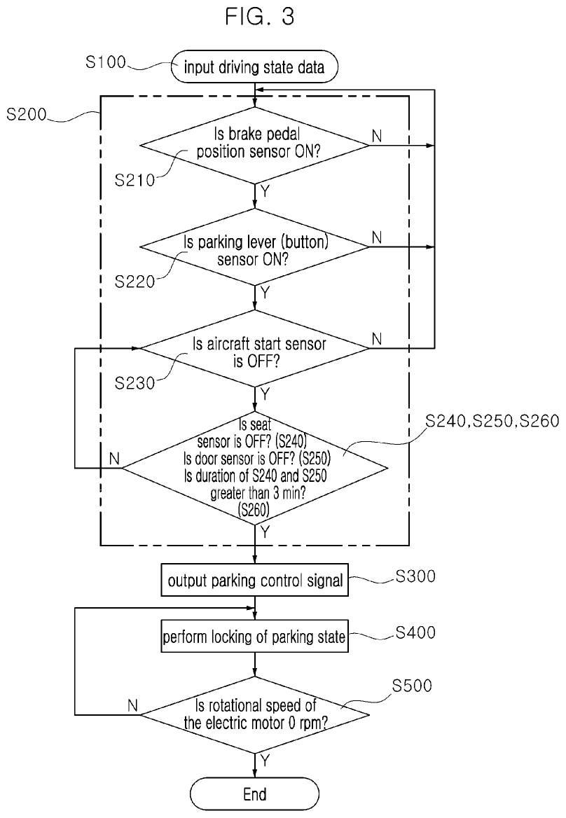

Referring to FIG. 3, a parking control method of the present disclosure may include the steps of: inputting driving state data of an aircraft (S 100); determining by the aircraft control unit 400 whether an activation condition of a parking locking function is satisfied based on the input data (S 200): outputting a parking control signal to the motor controller 500 when the activation condition of the parking locking function is satisfied by the aircraft control unit 400 (S 300); and stopping a rotation of the electric motor shaft 32 for making a parking state by the motor controller 500 based on a parking locking signal from the motor controller 500 and locking the parking state (S400).

The step of inputting driving state data (S 100) may receive signals detected by a plurality of sensors. The plurality of sensors may include at least one of a brake pedal position sensor 310, a parking lever (button) sensor 320, an aircraft start sensor 330, a seat belt sensor 240, and a door sensor 350, whose detected signal may be input to the aircraft control unit.

The aircraft control unit 400 may determine at S 200 whether the activation condition of the parking locking function is satisfied based on the data which is input at S 100.

To determine whether then activation condition of the parking locking function is satisfied, aircraft control unit 400 may determine that the brake pedal position sensor 310 is ON when a depression angle of the brake pedal (not shown) corresponds to a predetermined range at S 210, the parking lever (button) sensor 320 is ON when the pilot manipulates the parking lever (or button) (not shown) at S220, and the aircraft start sensor 330 is OFF when the aircraft drive motor stops at S 230.

Accordingly, the aircraft control unit 400 may determine that the activation condition of the parking locking function is satisfied when all of the conditions of the steps S210, 220 and 230 are satisfied and continue to proceed further.

However, if any one of the conditions for activation condition of the parking locking function in steps S210, 220, and 230 is not satisfied, return to step S210 and check again whether the brake pedal position sensor 310 is ON.

Meanwhile, by strengthening the activation condition of the parking locking function, it is possible to prevent unnecessary performing of the parking locking function contrary to the pilot's intention.

For instance, after the step of checking whether the aircraft start sensor 330 is OFF at S 230, the aircraft control unit 400 may further confirm that the seat belt sensor 340 is OFF to check whether the pilot unfastens the seat belt and leaves the pilot compartment at S 240.

In addition, the aircraft control unit 400 may further confirm that the door sensor 350 is OFF to check whether the pilot closes the door of the pilot compartment and leaves the aircraft at S 250.

In this case, the aircraft control unit 400 may determine whether the duration of steps S240 and S250 exceeds a predetermined time period at S260. The duration is preferably set to be about 3 min, since the pilot may temporarily leave the aircraft. However, it is of course that the duration may be set differently according to conditions as needed.

If the aircraft control unit 400 determines that the activation condition of the parking locking function is satisfied at S 200, the aircraft control unit 400 may output a parking control signal to the motor controller 500 at S 300 to perform the parking locking step at S 400.

In a parking state in which the rotor disc 10 is stopped due to a braking operation of the caliper 40, the parking locking step (S400) may be performed in response to a parking locking signal for locking and maintaining the parking state from the motor controller 500.

Here, the parking state is defined as a state below. That is, when the pilot may manipulate the parking lever (button), a parking control signal from the aircraft control unit 400 may be transmitted to the motor controller 500. The rotational force of the rotating shaft 32 caused by a forward rotation of the electric motor 31 of the wheel brake assembly 100 may be transmitted to the rocker arm 36 of the pressing part P via the power transmission part T. As shown in FIG. 5, the rotation of the rocker arm 36 may cause the push rod 37 to move downwards to the maximum, so that the piston 38 may extend to operate the caliper 40 to press friction pads 50 against both sides of the rotor disc 10, stopping a rotation of the axle 12 on the ground.

On the other hand, in order to release the parking state as described above, when the pilot may release the parking lever (button), another parking control signal is outputted from the aircraft control unit 400 to the motor controller 500. Accordingly, the rotational force of the rotating shaft 32 caused by a reward rotation of the electric motor 31 of the wheel brake assembly 100 may be transmitted to the rocker arm 36 via the power transmission part T. The rotation of the rocker arm 36 may cause the push rod 37 to move upwards to the maximum, so that the piston 38 may retract to operate the caliper 40 for separating the friction pads 50 from both sides of the rotor disc 10, enabling the axle 12 to freely rotate on the ground.

The parking locking step (S400) for preventing the aircraft from arbitrarily moving by locking the parking state as described above may be performed by the parking locking mechanism 600.

The parking locking mechanism 600 may perform a locking operation by a first current value applied to a solenoid 610 by a parking locking signal from the motor controller 500. The parking locking mechanism 600 may implement a conventional mechanism for performing a parking locking in which the rotation of the electric motor shaft 32 is stopped by an operation of the friction member 620 or a one-way clutch 630 which is operated by the solenoid 610.

In addition, the aircraft control unit 400 may confirm whether the parking locking step at S 400 is properly performed. In other word, the aircraft control unit 400 may determine whether the electric motor 31 is stopped, that is, whether the rotational speed of the electric motor 31 is 0 rpm at S 500.

If, at S 500, it is detected that the rotational speed of the electric motor 31 is not 0 rpm, this means that the electric motor shaft 32 rotates and the parking state has not been locked. Accordingly, in order to re-execute the parking locking operation, the process returns to the parking locking step at S 400.

On the other hand, the parking locking state as described above may be released when the aircraft start sensor 330 is ON by manipulation of the aircraft start switch by the pilot. Accordingly, a parking release signal is applied to the parking locking mechanism 600 from the motor controller 500 through the aircraft control unit 400. When a second current value according to the parking release signal is applied to the solenoid 610, the solenoid 610 is operated to release the friction member 620 or the one-way clutch 630 so that the electric motor 31 may rotate freely. Here, these first and second current values may be appropriately selected according to the braking torque required according to the aircraft, and may be stored in the memory (Y).

In the parking control method of the present disclosure, the motor controller 500 may be connected to the aircraft control unit 400 through a Controller Area Network (CAN) communication to control the electric motor 31.

In the parking control method of the present disclosure, the locked parking state may be displayed at the display unit D of the sash panel in the pilot's compartment by sound or lighting of a lamp through the aircraft unit 400, or may be delivered to the pilot's mobile phone as a push message through the communication unit 420.

As described above, the parking control of the present disclosure is performed using the predetermined first and second current values applied to the solenoid 610 of the parking locking mechanism 600 to lock or release the parking state thereof.

However, as the modification of the present disclosure, a parking state of the electric motor 31 may be controlled using a detection value for the ascending or descending position of the ball screw 34 or the push rod 37, or a rotational angle of the rocker arm 36 corresponding to the parking state.

In the above exemplary embodiment, it has been described that the electric motor 31 is used in the brake actuator 30, but as a modification of the present disclosure, a hydraulic motor (not shown) may be applied for the brake actuator 30. Here, the rotational force of the hydraulic motor may be applied to a gear train consisting of the plurality of spur gears 33 and converted into a linear displacement via the ball screw 34 to perform an operation of pressing or releasing the caliper 40 via the piston 38 may be almost the same as the described above, the description thereof will be omitted. Furthermore, the methods or the steps of algorithm described with reference to the embodiments proposed in this specification may be implemented in the form of program instructions executable through various computer systems and may be recorded in a computer-readable medium. The computer-readable medium may also include program (instruction) codes, data files, data structures, and the like independently or in the form of combination.

The program (instruction) codes for a parking control recorded in the memory (Y) may be specially designed and constructed for the present disclosure, or may be well-known and available to those skilled in the computer software arts. Examples of the computer-readable medium may include magnetic media such as hard discs, floppy discs, and magnetic tape: optical media such as CD ROM discs, DVD, Blu-ray discs; and semiconductor memory devices such as read-only memory (ROM), random access memory (RAM), and flash memory, which are specialized to store and perform program (instruction) codes. Examples of program (instruction) codes may include not only machine codes produced by a compiler but also high-level language codes capable of being executed by a computer using an interpreter or the like. The described hardware devices may be configured to operate as one or more modules or units to perform the operations of the above-described embodiments, and vice versa.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An apparatus of controlling a parking state of a brake for an aircraft, the apparatus comprising:
a data input unit of an aircraft driving state;
an aircraft control unit determining whether a parking locking function is activated based on the data of the data input unit and outputting a parking control signal;
a motor controller outputting a parking locking signal for controlling an operation of an electric motor of a brake assembly according to the parking control signal of the aircraft control unit; and
a parking locking mechanism for stopping a rotation of the electric motor in response to a parking locking signal from the motor controller and locking a parking state of the brake assembly.

2. The apparatus of claim 1, wherein the data input unit of the aircraft driving state is configured to receive signals detected by a plurality of sensors.

3. The apparatus of claim 2, wherein the plurality of sensors includes at least one of a brake pedal position sensor, a parking lever (button) sensor, and an aircraft start sensor.

4. The apparatus of claim 1, wherein aircraft control unit is configured to determine whether an activation condition of a parking locking function is satisfied based on the data collected via the data input unit of the aircraft driving state from the plurality of sensors.

5. The apparatus of claim 4, wherein the activation condition of the parking locking function is determined based on signals from the brake pedal position sensor, the parking lever (button) sensor, and the aircraft start sensor.

6. The apparatus of claim 5, wherein the activation condition of the parking locking function is determined by additionally including signals from a seat belt sensor and a door sensor.

7. The apparatus of claim 1, wherein the parking locking mechanism is configured to perform a parking locking function by stopping a rotation of an electric motor shaft using a friction member or a one-way clutch operated by a solenoid according to the parking locking signal from the motor controller.

8. The apparatus of claim 1, wherein the aircraft control unit further comprises a display unit for externally displaying a parking locking state by the parking locking mechanism.

9. The apparatus of claim 1, wherein the aircraft control unit further comprises a communication unit for notifying a parking locking state by the parking locking mechanism to a pilot's mobile phone.

10. A method of controlling a parking state of a brake for an aircraft comprises steps of:
inputting driving state data of an aircraft;
determining whether an activation condition of a parking locking function is satisfied by an aircraft control unit based on the input data;
outputting a parking control signal to a motor controller when the activation condition of the parking locking function is satisfied by the aircraft control unit; and
locking a parking state where a rotation of an electric motor shaft is stopped via a parking locking mechanism according to a parking locking signal from the motor controller, and maintaining the locked parking state of the electric motor shaft.

11. The method of claim 10, wherein the step of inputting driving state data receives signals detected by a plurality of sensors.

12. The method of claim 11, wherein the plurality of sensors includes at least one of a brake pedal position sensor, a parking lever (button) sensor, an aircraft start sensor, a seat belt sensor, and a door sensor.

13. The method of claim 10, wherein in the step of determining whether an activation condition of a parking locking function is satisfied, the activation condition of the parking locking function is met when the brake pedal position sensor is ON, the parking lever (button) sensor is ON, and the aircraft start sensor is OFF.

14. The method of claim 13, wherein the activation condition of the parking locking function is further determined by whether the seat belt sensor is OFF and the door sensor is ON for a predetermined period of time.

15. The method of claim 14, wherein the predetermined period of time is preferably set to 3 minutes.

16. The method of claim 14, wherein in a state where a rotation of a rotor disc is stopped via a pair of calipers by manipulation of the brake pedal or the parking lever (button) by the pilot, the parking locking step is performed by applying a parking locking signal with a first current value to the electric motor by the motor controller, locking a parking state where a rotation of an electric motor shaft is stopped via a parking locking mechanism including a friction member or a one-way clutch which is operated by a solenoid according to the parking locking signal, and maintaining the locked parking state.

17. The method of claim 16, wherein unlocking of the parking state is performed by applying a parking release signal with a second current value to the solenoid by the motor controller, and unlocking the parking state via the parking locking mechanism including the friction member or the one-way clutch operated by a solenoid to enable the electric motor shaft to rotate freely.

18. The method of claim 10, wherein the motor controller is connected to the aircraft control unit through a Controller Area Network (CAN) communication to control the electric motor.

19. The method of claim 16, wherein the aircraft control unit is configured to display the locked parking state by sound or lighting of a lamp.

20. The method of claim 16, wherein the aircraft control unit is configured to notify the locked parking state to the pilot's mobile phone as a push message.
